(19) United States
(12) Patent Application Publication
(10) Pub. No.: US 2013/0194892 A1
(43) Pub. Date: Aug. 1, 2013

(54) Autonomous System for Hydrofracture Monitoring

(71) Applicants: Daniel Golparian, Tokyo (JP); William B. Underhill, Richmond, TX (US)

(72) Inventors: Daniel Golparian, Tokyo (JP); William B. Underhill, Richmond, TX (US)

(21) Appl. No.: 13/360,787

(22) Filed: Jan. 29, 2012

(51) Int. Cl. G01V 1/00; G06F 19/00

(52) U.S. Cl. 367/25; 702/6

(57) ABSTRACT

A system includes a plurality of sensor assemblies that are adapted to be deployed in a wellbore and acquire sensor data indicative of microseismic activity due to a hydraulic fracturing operation in the wellbore. At least one of the sensor assemblies includes a command interface and at least one sensor and is adapted to use the command interface to identify a command stimulus that is communicated downhole and initiate an acquisition by the sensor in response to identifying the command stimulus.

### BACKGROUND

After a well is drilled into a hydrocarbon-bearing reservoir, fracturing operations may be conducted to enhance the production of oil and gas from the reservoir. One way to improve or maximize the flow of fluids to the well from the reservoir is to employ hydraulic fracturing, or hydrofracturing, to create larger, man-made fractures. The fractures may extend outwardly from the wellbore into the reservoir rock. These larger fractures typically connect to pre-existing fractures and flow pathways in the reservoir rock and may facilitate enhanced hydrocarbon fluid recovery.

In hydrofracturing, a fluid (a fluid having relatively high viscosity, for example) is pumped down into the well at high pressures for relatively short periods of time (a few hours, for example). The high pressure fluid exceeds the strength of the reservoir rock and opens one or more fractures in the rock. A propping agent (often called “proppant”), such as sand carried by the high viscosity additives, is pumped into the fracture(s) to keep the fracture(s) from closing when the pumping pressure is released. After some time the high viscosity fluid becomes a lower viscosity fluid. Both the injected water and the now low viscosity fluid travel back through the man-made fracture(s) to the well and up to the surface.

The location and growth of hydraulically-induced fractures (the fracture azimuth, length, height, and growth history, for example) may be monitored during fracturing by sensing or detecting micro-seismic activity-related events. In this manner, the results of the micro-seismic event monitoring may be used for such purposes as improving the fracturing job (e.g., varying such parameters as treating pressure, rate, proppant concentration and so forth) and providing an operator with recommendations for reservoir management (e.g., finding suitable infill drilling locations, determining completion practices, and so forth).

### SUMMARY

In some implementations, a system may include a plurality of sensor assemblies that are adapted to be deployed in a wellbore to acquire sensor data indicative of microseismic activity due to a hydraulic fracturing operation in the wellbore. At least one of the sensor assemblies may include a command interface and at least one sensor. The sensor assembly may be adapted to use the command interface to identify a command stimulus that is communicated downhole and initiate an acquisition by the sensor in response to identifying the command stimulus.

In another implementation, a technique includes deploying an array of sensor assemblies downhole in a wellbore. The technique includes using the deployed sensor assemblies to detect microseismic activity due to a hydraulic fracturing operation in the wellbore, which may include communicating a command stimulus downhole to cause the sensor assemblies to begin acquiring data indicative of at least one microseismic event and recording the data locally in the sensor assemblies. The technique may further include retrieving recorded data from the retrieved sensor assemblies.

In yet another implementation, a sensor assembly may be adapted to be deployed downhole in a well and includes a processor, an interface and a sensor. The processor is adapted to use the interface to identify at least one stimulus that is communicated downhole and in response to the identification, initiate an acquisition by the sensor.

Advantages and other desired features will become apparent from the following drawings, description and claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying drawings illustrate the various implementations described herein and are not meant to limit the scope of various technologies described herein. The drawings are as follows:

FIG. 1 is a schematic diagram of a hydrofracture monitoring system in a state in which sensors of the system are retracted according to an exemplary implementation;

FIG. 2 is a schematic diagram of the hydrofracture monitoring system of FIG. 1 in a state in which sensors of the system are extended according to an exemplary implementation;

FIGS. 3, 4 and 5 depict a flow diagram of a technique to use an autonomous system of sensor units to monitor hydrofracturing according to an exemplary implementation;

FIG. 6 is a schematic diagram of a sensor station unit of the hydrofracture monitoring system of FIG. 1 according to an exemplary implementation;

FIG. 7 is a schematic diagram of a hydrofracture monitoring system according to a further exemplary implementation;

FIG. 8 is a schematic diagram of a base sensor station unit of the hydrofracture monitoring system of FIG. 7 according to an exemplary implementation; and

FIG. 9 is a schematic diagram of a remote sensor station unit of the hydrofracture monitoring system of FIG. 7 according to an exemplary implementation.

### DETAILED DESCRIPTION

Illustrative embodiments and aspects of the hydraulic fracture monitoring systems, methods, and apparatus are described below. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such development effort might be complex and time-consuming, but would nevertheless be a routine undertaking for those of ordinary skill in the art having the benefit of this disclosure.

Reference throughout the specification to “one embodiment,” “an embodiment,” “some embodiments,” “one aspect,” “an aspect,” or “some aspects” means that a particular feature, structure, method, or characteristic described in connection with the embodiment or aspect is included in at least one embodiment of the present disclosure. Thus, the appearance of the phrases “in one embodiment” or “in an embodiment” or “in some embodiments” in various places throughout the specification are not necessarily all referring to the same embodiment. Furthermore, the particular features, structures, methods, or characteristics may be combined in any suitable manner in one or more embodiments. The words “including” and “having” shall have the same meaning as the word “comprising.”

Moreover, inventive aspects lie in less than all features of a single disclosed embodiment. Thus, the claims following the Detailed Description are hereby expressly incorporated into this Detailed Description, with each claim standing on its own as a separate embodiment of this disclosure.

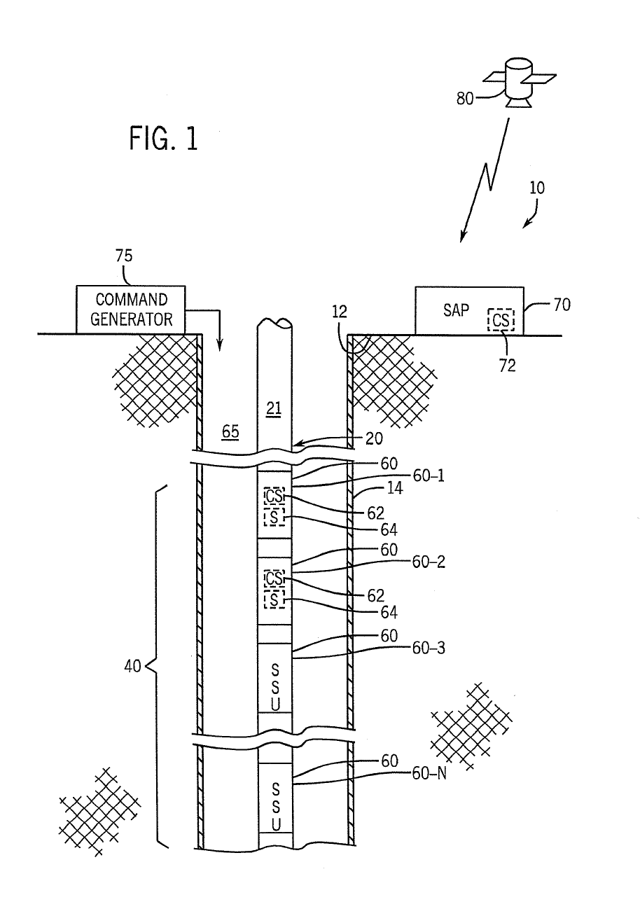

Referring to FIG. 1, in accordance with implementations disclosed herein, a hydraulic fracture, or hydrofracture, monitoring system 10 includes an array 40 of sensor assemblies, called “sensor station units 60” (N exemplary sensor station units 60-1, 60-2, 60-3 . . . 60-N, being depicted in FIG. 1). The sensor station units 60 are deployed in a well (a well extending into a hydrocarbon-bearing reservoir, for example) for purposes of acquiring and recording sensor data indicative of the growth and locations of fractures that are induced by a hydraulic fracturing operation. More specifically, in accordance with implementations disclosed herein, the sensor station units 60 may be disposed on a tubing string 20, which extends into the well; and in accordance with some implementations, the sensor station units 60 may ultimately be retrieved from the well for purposes of retrieving the recorded data.

For the exemplary implementation that is depicted in FIG. 1, the tubing string 20 extends downhole inside a wellbore 12 that is cased by a tubular casing string 14. However, the array 40 may be deployed in uncased wellbores, in accordance with other implementations. It is noted that although FIG. 1 depicts a vertical wellbore 12, the systems and techniques that are disclosed herein may likewise be applied to lateral wellbores, in accordance with other implementations. Moreover, although the schematic depiction of the tubing string 20 is simplified in FIG. 1 for purposes of clarifying the operation of the sensor station units 60, the string 20 may have a number of different tools (e.g., packers, stabilizers, eccentralizers, and so forth) that are not shown in this depiction.

The sensor station units 60 are autonomous, in that the sensor station units 60 independently record and store data; and the sensor station units 60 may be independently controlled from the Earth surface of the well for such purposes as controlling when the sensor units 60 are acquiring and recording data; preparing the sensor units 60 for such data acquisitions; preparing the sensor station units 60 for retrieval from the well and/or moving to another location in the well; controlling power consumption states of the sensor station units 60; and so forth.

In accordance with some implementations, the tubing string 20 may be used in connection with a hydrofracturing operation that is being monitored using the sensor station units 60. In this manner, during the hydrofracturing operation, a central passageway 21 of the tubing string 20 may be used to communicate a hydraulic fracturing fluid downhole, and the tubing string 20 may contain one or more packers to create one or more annular isolated regions in the well, which are used in the hydrofracturing operation. In other implementations, the sensor station units 60 may be conveyed downhole into the well on a conveyance mechanism other than on a tubing string that is used to communicate fracturing fluid into the well. Thus, many variations are contemplated and are within the scope of the appended claims.

Depending on the particular implementation, the sensor station units 60 may be attached (attached using clamps, for example) to the exterior of the tubing string 20, or the sensor station units and 60 may be housed in generally tubular subs, or shuttles, that form corresponding sections of the tubing string 20.

In accordance with some implementations, each sensor station unit 60 may contain a clock source 62 (an oscillator, for example) that may be synchronized to a reference clock source. For example, the reference clock source may be a clock source 72 of a surface acquisition platform 70. As a more specific example, in accordance with some implementations, the clock source 72 may be synchronized to a global time indicated by global positioning satellite (GPS) signals that are provided by a GPS satellite 80.

As a non-limiting example, before the sensor station units 60 are used to acquire data in the well in connection with the hydrofracture monitoring, the clock sources 62 of the sensor station units 60 are synchronized to the clock source 72 of the surface acquisition platform 72. For example, in accordance with some implementations, before the tubing string 20 is deployed in the well, the clock sources 62 are electrically coupled (through a wired and/or wireless connection, depending on the particular implementation) to the clock source 72 for purposes of synchronizing these two clock sources. As another example, the clock sources 62 may be synchronized to the clock source 72 after the tubing string 20 is deployed in the well, using, for example, an inductive coupling tool that is run into the well for purposes of communicating with the clock sources 62 to perform the synchronization.

Regardless of the mechanism that is used, when the sensor station units 60 are ready to acquire data, the clock sources 62 maintain clock signals that are synchronized to the clock signal of the surface acquisition platform 70. Therefore, the sensor station units 60 may timestamp data acquired by the units 60 using these clock signals. As a more specific example, in accordance with some implementations, the clock sources 62 and 72 may be real time clock (RTC) sources. Thus, in accordance with some implementations, the sensor station units 60 may timestamp their acquired data with RTC values.

Further implementations are contemplated and are within the scope of the appended claims. For example, in further implementations, a single clock source of one of the sensor station units 60 may be synchronized to the clock source 72; and locked loop circuits (phase locked loops (PLL), for example) may be employed in the other sensor station units 60 for purposes of synchronizing the local clock signals of the other sensor station units 60 to the clock source 72.

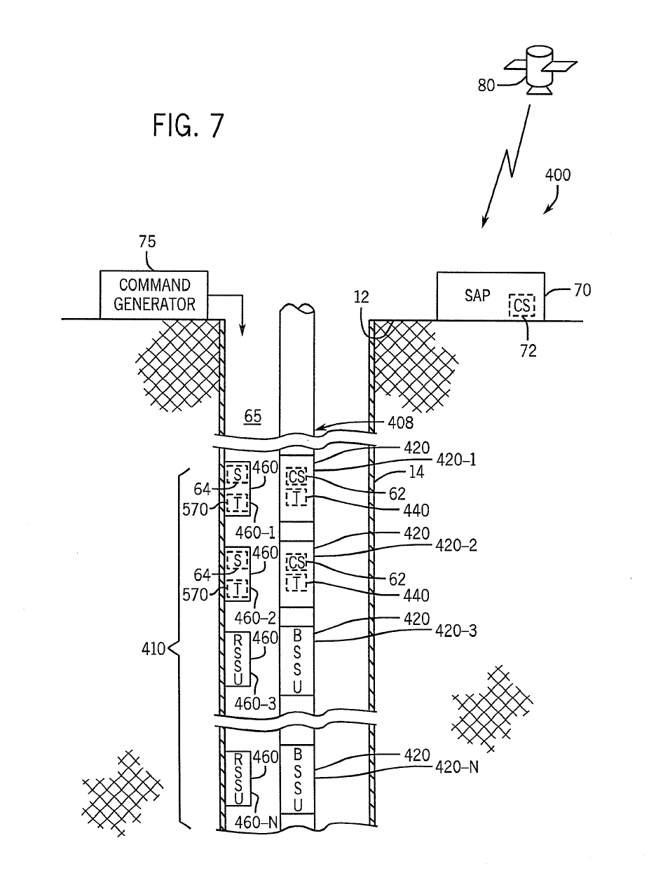

Each sensor station unit 60 includes a motion sensor 64 (a geophone, for example) for purposes of acquiring sensor data potentially indicative of micro-seismic activity (i.e., for purposes of acquiring data potentially indicative of micro-seismic events), as further described herein. For the implementation depicted in FIG. 1, the sensors 64 are contained in, or part of, the tubing string 20. However, in accordance with further implementations discussed below in connection with FIGS. 7-9, the sensors 64 may be separate from the tubing string 20 and attached to the casing string 14.

In accordance with some implementations, the sensor station units 60 may locally store acquired sensor data in their internal memories, until the data is retrieved from the memories. In this manner, the sensor data may be retrieved from the sensor station units 60 when the units are retrieved to the Earth surface of the well. In further implementations, the sensor data acquired by the sensors 64 may be communicated uphole to the surface acquisition platform 70 using one of a number of different communication techniques, depending on the particular implementation. For example, in accordance with some implementations, the tubing string 20 may be a wired tubing string in which electrical wires are embedded within the wall of the string 20. These wires may be configured to communicate telemetry signals; and the wires may be configured to communicate power, in accordance with some implementations. In further implementations, wireless signaling may be used for purposes of communicating sensor data uphole. In this manner, a technique such as acoustic signaling, electromagnetic signaling, and so forth, may be employed.

In accordance with some implementations, the system 10 includes an Earth surface-disposed command generator 75 that is used for purposes of communicating command-encoded stimuli downhole for purposes of communicating with the sensor station units 60 to allow a surface operator to control the sensor station units. As a non-limiting example, in accordance with some implementations, this communication may be a wireless communication in that the command generator 75 may communicate stimuli to the sensor station units 60 by selectively modulating the pressure of fluid in the well, which ultimately results in the corresponding modulation of pressure in an annulus 65 that surrounds the sensor station units 60.

In this manner, in accordance with some implementations, the command generator 75 may generate pressure pulses, which encode various commands to which the sensor station units 60 respond for purposes of directing operations of the units 60. It is noted, however, that in accordance with other implementations, command-encoded stimuli other than fluid pressure pulses may be used for purposes of communicating commands to the sensor station units 60. In this manner, in accordance with other implementations, such wireless communication techniques as electromagnetic communication, acoustic communication and so forth may be employed. Moreover, regardless of the particular type of wireless communication that is employed, the wireless communication may be used to communicate information (configuration information, requests, and so forth) other than commands for the sensor station units 60. Thus, many variations are contemplated and are considered to be within the scope of the appended claims.

In accordance with some implementations, a given sensor station unit 60 may operate in one or more power consumption states. In this manner, in accordance with some implementations, when the sensor station units 60 are first deployed downhole, the sensor station units 60 may be placed in relatively low power consumption states, i.e., states in which various components (microprocessors and so forth) of the units 60 are idle and consume relatively small amounts of power. For purposes of acquiring sensor data, however, the sensor station units 60 may subsequently transition to higher power consumption states in order to allow the components (microprocessors and so forth) of the units 60 to enter active modes for purposes of acquiring and processing sensor data. After the sensor data has been acquired, the sensor station units 60 may subsequently transition back to the lower power consumption states.

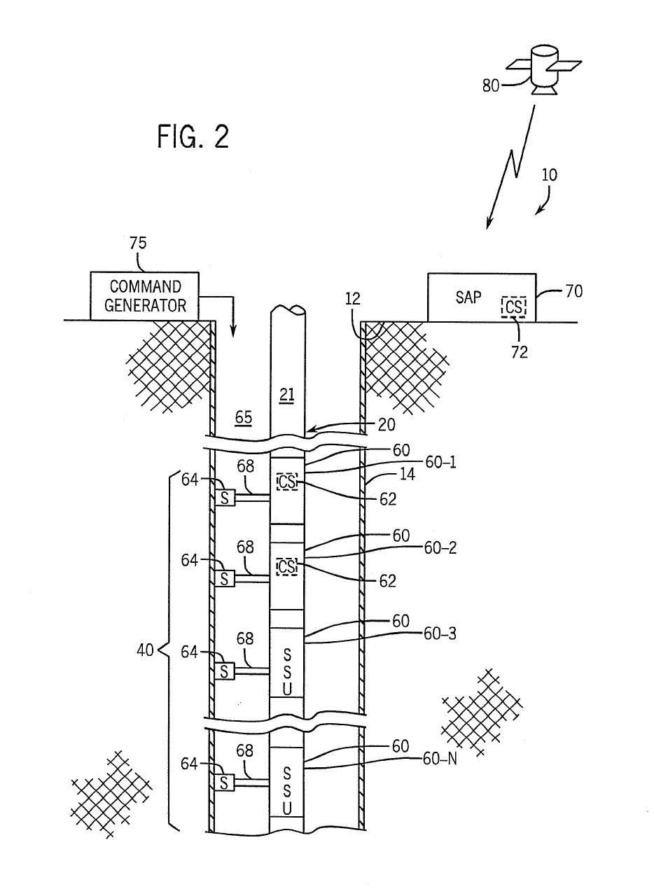

In accordance with some implementations, the sensor station units 60 may be directed via the above-described command communication to selectively extend and retract their sensors 64. More specifically, as a non-limiting example depicted in FIG. 2, in accordance with some implementations a given sensor station unit 60 radially extends its associated sensor 64 for purposes of preparing the unit 60 to monitor microseismic activity monitoring.

As a more specific non-limiting example, in accordance with some implementations, the sensor station unit 60 includes an actuator (not shown in FIG. 2) that selectively radially extends an actuator-moveable member 68 that is secured to the unit's sensor 64 to acoustically couple the sensor 64 to the wall of the casing string 14. In this manner, in accordance with some implementations, the member 68 may radially extend the sensor 64 to contact an inner surface of the casing string wall during an acquisition mode of the sensor station unit 60.

Using these same mechanisms, the sensor station units 60 may also retract the sensors 64. More details regarding possible mechanisms that the sensor station units 60 may employ to extend and retract their sensors 64 may be found in U.S. Patent Application Publication No. US 2011/0188348 A1, entitled, “METHOD AND APPARATUS FOR MONITORING ACOUSTIC ACTIVITY IN A SUBSURFACE FORMATION,” which was published on Aug. 4, 2011, and is hereby incorporated by reference in its entirety.

During the deployment of the array 40 downhole, the sensors 64 are retracted. Moreover, in preparation for retrieving the array 40 from the well 10 or repositioning the array 40 within the well, the sensor station units 60 are directed (via command stimuli) to retrieve their respective sensors 64.

In accordance with some implementations, the command generator 75 communicates encoded stimuli (e.g., pressure pulses, as a non-limiting example) into the well for purposes of controlling and configuring the sensor station units 60. It is noted that, in accordance with some implementations, due to the autonomous nature of the sensor station units 60, the units 60 may independently detect and respond to the stimuli. Thus, for example, the command generator 75 may communicate a series of fluid pressure pulses into the well that indicate a command to extend the sensors 64; and the sensor station units 60 may independently identify the command and extend their sensors 64. In further implementations, the sensor station units 60 may be addressable: the command generator 75 may encode addresses into the stimuli such that a given sensor station unit 60 responds upon recognizing its address. Thus, many variations are contemplated that are within the scope of the appended claims.

As a non-limiting list of examples, the stimuli communicated into the well may be used for purposes of extending/retracting the sensors 64; controlling the power consumption states of the sensor station units 60; configuring the sensor station units 60 in preparation for an upcoming acquisition mode; placing the seismic sensor station units 60 in corresponding acquisition modes; transitioning sensor stations units 60 from respective acquisition modes to inactive modes; regulating parameters (time sampling rates, as a non-limiting example) of the sensor station units 60; and so forth.

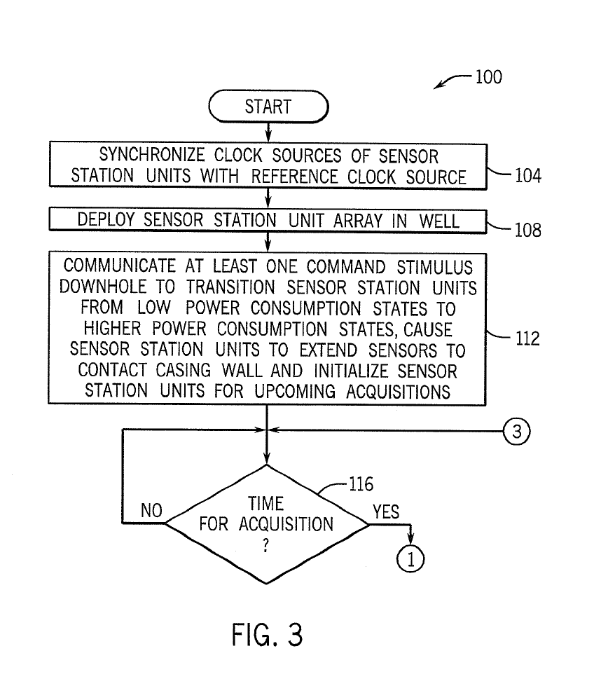

As a more specific example, FIGS. 3, 4 and 5 depict an exemplary technique 100 for deploying and using the sensor station units 60 in accordance with some implementations. Referring to FIG. 3, the technique 100 may include synchronizing (block 104) the clock sources 62 of the sensor station units 60 with the reference clock source 72 of the surface acquisition platform 70 (synchronizing the clock sources 62 before the array 40 is deployed inside the well 10, for example), pursuant to block 108. After the array 40 is deployed in position, at least one command stimulus may be communicated downhole to transition each of the sensor station units 60 from a relatively low power consumption state to a relatively higher power consumption state, cause each of the sensor station units 60 to extend its sensor to contact the casing wall, and initialize each of the sensor station units 60 for an upcoming acquisition, pursuant to block 112.

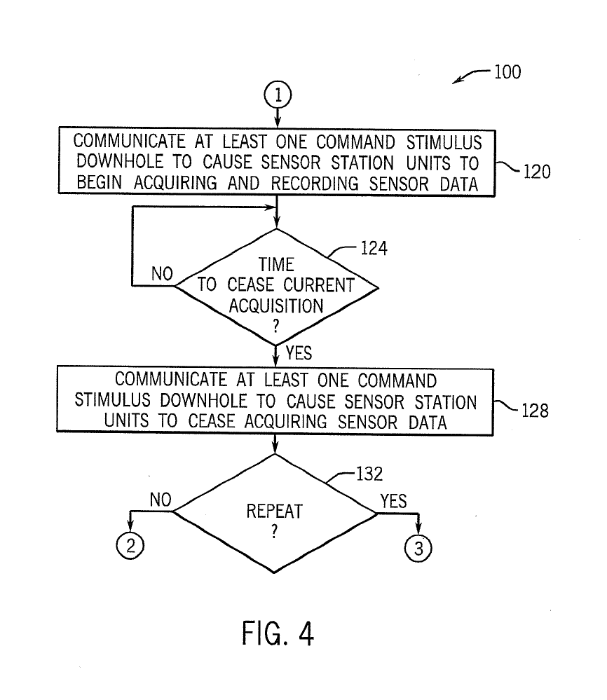

When a determination is made (decision block 116 of FIG. 3) that the sensor station units 60 should acquire data indicative of potential microseismic activity, the technique 100 includes communicating (block 120 of FIG. 4) at least one command stimulus downhole to cause the sensor station units 60 to initiate an acquisition interval, i.e., begin acquiring and recording sensor data until (for example) another command is communicated downhole to end the acquisition interval. Referring to FIG. 4, when a determination is made (decision block 124) that the current acquisition period is to end, the technique 100 includes communicating (block 128) at least one command stimulus downhole to cause the sensor station units 60 to cease acquiring sensor data.

It is noted that the above-described sensor data acquisition may be repeated. In other words, if a determination is made pursuant to decision block 132 to repeat an acquisition, control may return to decision block 116, in accordance with some implementations. Thus, in each acquisition, a given sensor station unit 60 stores timestamped sensor data indicative of the data acquired by a sensor during the acquisition.

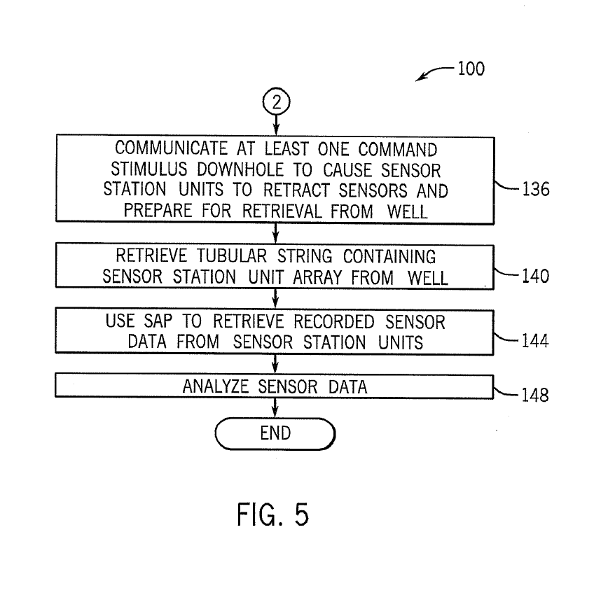

Referring to FIG. 5, after the acquisitions are complete, the technique 100 includes communicating (block 136) at least one command stimulus downhole to cause the sensor station units 60 to retract their sensors 64 and prepare for retrieval from the well. Subsequently, the tubing string 20 is retrieved from the well, pursuant to block 140. In further implementations, command stimuli may be communicated downhole to cause the sensor station units 60 to retract their sensors for purposes of repositioning the array 140 to another downhole location.

After the array 40 is retrieved from the well, the surface acquisition platform 70 may then be used, pursuant to block 144, to retrieve the recorded sensor data from the sensor station units 60. The retrieved sensor data may then be analyzed (block 148) for purposes of identifying microseismic activity, developing or refining a fracture network model, identifying fracture locations, identifying fracture volumes; and so forth. In further implementations, the data may be retrieved from the sensor station units 60 using a reader that is conveyed downhole in proximity to the units 60 to retriever the stored data from the units 60 (using inductive coupling, for example). In yet further implementations, the sensor station units 60 may use an uphole telemetry system to communicate the sensor data uphole. Thus, many variations are contemplated, which are within the scope of the appended claims.

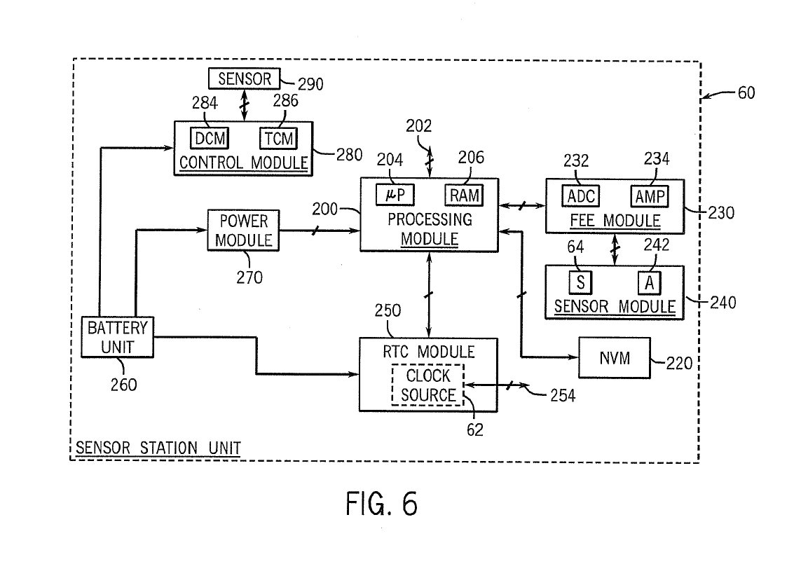

FIG. 6 depicts an exemplary architecture for the sensor station unit 60 in accordance with some implementations. It is noted that the sensor station unit 60 may employ other architectures, in accordance with other implementations. For this example, the sensor station unit 60 includes a sensor module 240, which includes the sensor 64 and an actuator 242 (a stepper motor or a linear motor, as non-limiting examples). In accordance with some implementations, the sensor 64 may be a motion sensor such as a Geophone ACcelerometer (GAC), which is available from Schlumberger. Other sensors may be employed in accordance with other implementations.

The signal that is provided by the sensor 64 may be conditioned by a front end electronics module 230 of the sensor station unit 60, in accordance with some implementations. In this manner, the front end electronics module 230 may include one or more components as an analog-to-digital converters (ADCs) 232, one or more amplifiers 234 and so forth. Moreover, in accordance with some implementations, the front end electronics module 230 may include, for example, a motor driver for purposes of generating signals to control the actuator 242 of the sensor module 240. Moreover, the front end electronics module 230 may contain one or more drivers for purposes of communicating signals to the sensor module 240 for purposes of calibrating components of the sensor module 240 and communicating commands to the sensor module 240.

In accordance with some implementations, the sensor station unit 60 further includes a processing module 200, which, as some non-limiting examples, may provide general housekeeping tasks; timestamps the sensor data; routes data between the sensor(s) 64 and a non-volatile memory 220 for purposes of locally recording the timestamped sensor data in the unit 60 during an acquisition interval; executes machine-executable instructions to control the general operation of the sensor station unit 60; and so forth. For these purposes, the processing module 200 may include a processor 204, such as a microprocessor core, a microprocessor, multiple microprocessor cores, a microcontroller, and so forth. In some implementations, the non-volatile memory 220 may further store a copy of machine executable code that is executed by the processing module 200.

Regardless of its particular form, the processing module 200 may include a volatile memory, such as a random access memory (RAM) 206, for purposes of temporarily storing data and machine executable instructions for the processing module 200. As depicted in FIG. 6, in accordance with some implementations, the processing module 200 includes a port 202 for purposes of coupling the sensor station unit 60 to the surface acquisition platform 70 for purposes of retrieving the stored sensor data (locally stored in the non-volatile memory 220) from the sensor station unit 60 when the unit 60 is retrieved from the well.

The sensor station unit 60 further includes a real time clock (RTC) module 250, in accordance with some implementations. In general, the RTC module 250 may include a port 254 for purposes of synchronizing the clock source 62 with the clock source 72 of the surface acquisition platform 70. In this manner, in accordance with some implementations, the port 254 may be used to synchronize an oscillator of the module 250 with the clock source 62.

Among its other features, in accordance with some implementations, the sensor unit 60 includes a battery unit 260, which contains one or more battery cells for purposes of supplying power to the components of the sensor station unit 60. This power may be supplied directly to the components or may be supplied through a power module 270. In this manner, the power module 270 may contain power conditioning circuitry (linear regulators, switching regulators, filters, and so forth) for purposes of producing the supply voltages for components of the sensor station unit 60. The sensor station unit 60 may further include a control module 280, which serves as a command interface for the sensor station unit 60.

In this regard, in accordance with some implementations, the sensor station unit 60 includes a sensor 290 (a fluid pressure sensor, as a non-limiting example), which is coupled to the control module 280 to monitor the annulus 65 (see FIG. 1, for example) to detect the communication of encoded pressure pulses (as a non-limiting example), which may indicate commands, configuration parameters, and so forth for the sensor station unit 60. More specifically, in accordance with some implementations, the control module 280 includes a downlink control module (DCM) 284 that contains a processor (a microcontroller or a microprocessor core, as non-limiting examples), which is coupled to the sensor 290 for purposes of decoding pressure pulses that are communicated into the annulus 65 for purposes of identifying specific commands, requests, configuration directives, and so forth for the sensor station unit 60. Such commands may be commands to start an acquisition, stop an acquisition, control a sampling rate of the front end electronics 230, extend the sensor(s) 64, retract the sensor(s) 64, prepare the sensor station unit 60 for acquisition, transition the sensor station unit 60 between relatively low and relatively high power consumption states, and so forth.

In accordance with some implementations, the control module 280 may include a timing control module (TCM) 286, which may also be formed at least in part by the processor of the control module 280. In accordance with some implementations, the timing control module 286 provides a backup scheme to allow the sensor station unit 60 to execute a completely pre-programmed acquisition plan. Specifically, in accordance with some implementations, a “TCM DISABLE” command may be communicated from the Earth surface to the sensor station unit 60 for purposes of overriding execution of the pre-programmed acquisition plan and allowing full control over the starting and stopping of the acquisition from the Earth surface. In accordance with some implementations, the timing control module 286 may also control placing the sensor station unit 60 in the lower power consumption state after a predetermined interval of time elapses after the sensor station unit 60 undertakes certain activities, receives certain commands, or other events.

In further implementations, the sensor station unit 60 may include a telemetry interface (not shown) for purposes of communicating sensor data uphole. As non-limiting examples, the telemetry interface may communicate over wires of a wired pipe telemetry system or may communicate using wireless signaling. Thus, many variations are contemplated, which are within the scope of the appended claims.

Sensor assemblies have thus been described above, which are deployed as single units downhole as part of, for example, the tubing string 20. In accordance with further implementations, a sensor assembly may be deployed in the well, which is formed from two different components: a stationary component that contains a sensor and is secured to the casing string 14 (or wellbore wall if the wellbore is uncased); and a moveable part, which responds to command stimuli, stores and possibly communicates sensor data uphole and is part of a tubing string that is used to perform a hydrofracturing operation. Using an array of such sensor assemblies, the tubing string may be moved with respect to the stationary components of the assemblies for such purposes as positioning and repositioning the string to fracture another zone; acquiring measurements in another location; and so forth. The stationary components may be deployed downhole using a tool on a string that sets the stationary units to cause the stationary units to become attached to the casing string 14. In some implementations, the string may be the hydrofracturing tubing string, which contains the moveable parts of the sensor assemblies and a setting tool to set the stationary parts of the sensor assemblies. In further implementations, the stationary units may be deployed downhole on the casing string 14 and thus, may be installed with the string 14. Other variations are contemplated, which are within the scope of the appended claims.

As a more specific example, FIG. 7 depicts a monitoring system 400, which contains a tubing string 408 that contains moveable base sensor station units 420 (N base sensor station units 420-1, 420-2, 420-3 . . . 420-N, being depicted in FIG. 7), which communicate with stationary, remote sensor station units 460 (N remote sensor stations units 460-1, 460-2, 460-3 and 460-N, being depicted in FIG. 7), which are secured to the casing string 14. For this example, each base sensor station unit 420 has a corresponding remote sensor station unit 460. However, this is merely an example, as, in accordance with further implementations, a significantly larger number of the sensor station units 460 may be distributed along regions of interest of the well such that the tubing string 408 may be positioned and repositioned for purposes of using a lesser number of base sensor station units 420 to acquire the microseismic data.

Regardless of the particular implementation, FIG. 7 depicts a simplified view in which each base sensor station unit 420 communicates with a corresponding remote sensor station unit 460 of purposes of communicating sensor data acquired by the remote sensor station unit 460 to the base sensor station unit 420. As a non-limiting example, the base sensor station unit 420-1 may communicate with the remote sensor station unit 460-1; the base sensor station unit 420-2 may communicate with the remote sensor station unit 460-2; and so forth. In further implementations, a given base sensor station unit 420 may communicate with multiple remote sensor station units 460. Thus, many variations are contemplated, which are within the scope of the appended claims.

The base sensor station unit 420 contains a transceiver 440, which wirelessly communicates with a corresponding transceiver 570 of the remote sensor station unit 460. In this manner, using the wireless communication, the base sensor station unit 420 acquires sensor data acquired by a sensor 64 (a geophone, for example) of the remote sensor station unit 460. As a non-limiting example, the wireless communication may occur through the use of radio frequency (RF) signals, acoustic signals, optical signals, and so forth, depending on the particular implementation. Moreover, in addition to communicating sensor data, a given base sensor station unit 420 may communicate with a given remote sensor station unit 460 for such other purposes as communicating configuration data to the remote sensor station unit 460; changing power consumption states of the remote sensor station unit 460; setting up a pairing relationship between a given base sensor station unit 420 and a given remote sensor station unit 460; and so forth.

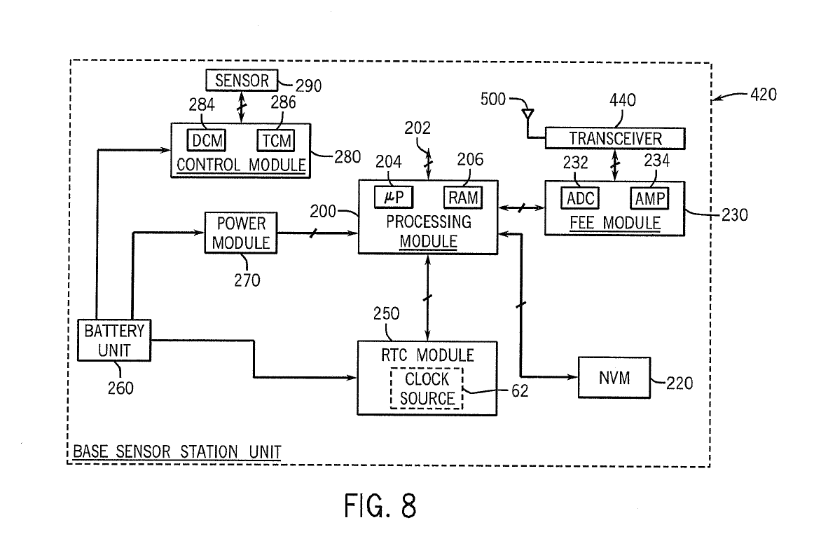

Referring to FIG. 8, in accordance with some implementations, the base sensor station unit 420 has a similar architecture design to the sensor station unit 60 (see FIG. 6), with similar reference numerals being used in FIG. 8 to denote the similarities. However, unlike the sensor station unit 60, the base sensor station unit 420 does not include the sensor module 292 (see FIG. 6, for example). Instead, the front end electronics module 230 of the base sensor station unit 420 communicates with the transceiver 440 for such purposes as receiving sensor data from a remote sensor station unit 460. As depicted in FIG. 8, the base sensor station unit 420 may include an antenna 500 for purposes of wirelessly transitioning and receiving wireless signals to communicate with the remote sensor station unit 460.

Similar to the sensor station unit 60, the base sensor station unit 420 may store the sensor data locally so that the data may be retrieved either through retrieval of the sensor station unit 60 or through interaction of a tool with the sensor station unit 60. In further implementations, the base sensor station unit 420 may contain a telemetry interface (not shown) for purposes of communicating sensor data uphole.

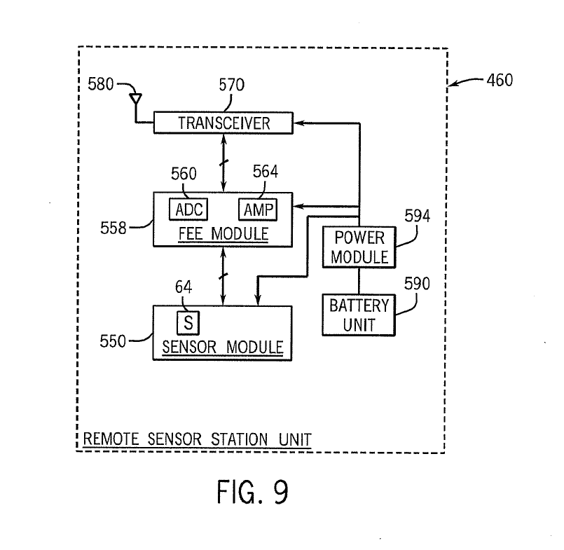

Referring to FIG. 9, in accordance with an exemplary architecture, the remote sensor station unit 460 may contain a front end electronics module 558, which includes various ADCs 560 and amplifiers 564 for such purposes as receiving sensor data from a sensor module 550 of the sensor station unit 460. In this regard, the sensor module 550 includes at least one motion sensor 64. As also depicted in FIG. 9, the remote sensor station unit 460 also includes the transceiver 570, which for the example that is depicted in FIG. 9 uses an antenna 580 for purposes of communicating with a corresponding base sensor station unit 420. Among its other features, the remote sensor station unit 460 includes a battery unit 590, which contains one or more cells for purposes of providing power for the components of the remote sensor station unit 460. In this regard, depending on the particular implementation, voltages from the battery unit 590 may be directly supplied to the components of the power-consuming remote sensor station unit 460 and/or a power module 590 of the unit 460 may contain power conditioning circuitry for purposes of providing voltages for the components.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A system, comprising:
a plurality of sensor assemblies adapted to be deployed in a wellbore and acquire sensor data indicative of microseismic activity due to a hydraulic fracturing operation in the wellbore, at least one of the sensor assemblies comprising a command interface and at least one sensor,
wherein the at least one sensor assembly is adapted to use the command interface to identify a command stimulus communicated downhole and initiate an acquisition by the sensor in response to identifying the command stimulus.

2. The system of claim 1, wherein the at least one sensor assembly is adapted to use the command interface to identify another command stimulus communicated downhole and cease using the sensor to acquire data in response to identifying the another command stimulus.

3. The system of claim 1, wherein at least one of the sensor assemblies comprises a first component contained on a tubing string and a second component secured to a casing string in which the tubing string extends, the second component comprising the at least one sensor, and the first and second components being adapted to communicate with each other.

4. The system of claim 1, wherein the at least one sensor assembly is adapted to use the command interface to identify another command stimulus communicated downhole and translate the sensor from a first position to a second position in response to identifying the another command stimulus.

5. The system of claim 1, wherein the at least one sensor assembly comprises a clock source adapted to be synchronized to a clock source outside of the wellbore.

6. The system of claim 1, wherein the at least one sensor assembly comprises a non-volatile memory to store the data acquired by the sensor and an interface to communicate the recorded data from the non-volatile memory.

7. The system of claim 1, wherein the sensor is adapted to record data indicative of a microseismic event.

8. A method, comprising:
deploying an array of sensor assemblies downhole in a wellbore;
using the deployed sensor assemblies to detect microseismic activity due to a hydraulic fracturing operation in the wellbore, the using comprising communicating a command stimulus downhole to cause the sensor assemblies to begin acquiring data indicative of at least one microseismic event and recording the data locally in the sensor assemblies; and
retrieving recorded data from the retrieved sensor assemblies.

9. The method of claim 8, further comprising:
communicating another command stimulus downhole; and
ceasing the acquiring data by the sensor assemblies in response to the another command stimulus.

10. The method of claim 8, further comprising:
communicating another command stimulus downhole; and
deploying sensors of the sensor assemblies in response to the another command stimulus.

11. The method of claim 8, wherein the using comprises wirelessly communicating sensor data between first components of the sensor assemblies disposed on a tubing string and second components of the sensor assemblies secured to a casing string into which the tubing string extends.

12. The method of claim 8, further comprising:
communicating a first additional command stimulus downhole;
communicating a second additional command stimulus downhole;
causing the sensor assemblies to begin acquiring data in response to the first additional command stimulus;
causing the sensor assemblies to cease acquiring data in response to the second command stimulus; and
repeating the acts of communicating the first additional command stimulus downhole, communicating the second additional command stimulus downhole, causing the sensor assemblies to begin acquiring data and causing the sensor assemblies to cease acquiring data.

13. The method of claim 8, further comprising selectively transitioning the sensor assemblies between different power consumption states while the sensor assemblies are deployed downhole.

14. A sensor assembly adapted to be deployed downhole in a well, comprising:
a processor;
an interface; and
a sensor,
wherein the processor is adapted to use the interface to identify at least one stimulus communicated downhole and in response to the identification of the at least one stimulus, initiate an acquisition by the sensor.

15. The sensor assembly of claim 14, wherein the processor is disposed on a first component of the sensor assembly disposed on a first tubing string and the sensor is disposed on a second component of the sensor assembly secured to a second tubing string into which the first tubing string extends.

16. The sensor assembly of claim 14, further comprising a non-volatile memory to store data acquired by the sensor and an interface to communicate data from the non-volatile memory.

17. The sensor assembly of claim 14, further comprising a battery to power components of the assembly.

18. The sensor assembly of claim 14, further comprising a clock source to be synchronized with a reference clock source outside of the well.

19. The sensor assembly of claim 14, wherein
the interface is adapted to identify an additional command stimulus communicated downhole in the well; and
the processor is adapted to cause the sensor to cease acquiring data in response to identification of the additional command stimulus.

20. The sensor assembly of claim 14, wherein
the interface is adapted to identify an additional command stimulus communicated downhole in the well; and
the processor is adapted to cause the assembly to change a power consumption state in response to identification of the additional command stimulus.
